(19) United States
(12) Patent Application Publication
(10) Pub. No.: US 2026/0199998 A1
(43) Pub. Date: Jul. 16, 2026

(54) WELDING SYSTEM, FEED CONTROL METHOD, AND COMMUNICATION CONNECTION METHOD

(71) Applicant: Kabushiki Kaisha Kobe Seiko Sho (Kobe Steel, Ltd.), Kobe-shi (JP)

(72) Inventors: Shogo NAKATSUKASA, Kanagawa (JP); Atsushi FUKUNAGA, Kanagawa (JP); Takaya HIGASHIRA, Kanagawa (JP); Shota SEKIGUCHI, Kanagawa (JP)

(73) Assignee: Kabushiki Kaisha Kobe Seiko Sho (Kobe Steel, Ltd.), Kobe-shi (JP)

(21) Appl. No.: 19/134,038

(22) PCT Filed: Oct. 11, 2023
(86) PCT No.: PCT/JP2023/036937

§ 371 Date: May 29, 2025

(30) Foreign Application Priority Data
Nov. 30, 2022 (JP) 2022-192369

(51) Int. Cl. B23K 9/12; B23K 9/095; B23K 9/10

(52) U.S. Cl. CPC B23K 9/125; B23K 9/0953; B23K 9/1043

(57) ABSTRACT

A welding system includes at least a welding control device, a welding power supply, a servo motor, and a servo amplifier configured to control the servo motor. At least the servo amplifier and the welding power supply are directly or indirectly connected to each other via a digital communication. The servo amplifier has a forward and reverse feed command generating unit configured to generate a feed command for forward feeding or reverse feeding based on setting information input via the digital communication. The servo amplifier is configured to output a control signal based on the generated feed command to the servo motor and output a synchronization signal related to the generated feed command to the welding power supply. The welding power supply is configured to calculate a wire position phase based on the synchronization signal.

### TECHNICAL FIELD

The present invention relates to a welding system, a feed control method, and a communication connection method.

### BACKGROUND ART

In the related art, gas-shielded arc welding is used for manufacturing automobiles, steel structures, construction machinery, and ships, and many other industries. In the gas-shielded arc welding, there is a demand for improvements in weldability including the reduction in spatter. In the related art, the method that is considered to be effective in reducing spatter includes a method of welding a welding wire (hereinafter, also referred to as simply a “wire”) while controlling at least one of welding conditions based on at least one of a tip position or a feed speed of the welding wire, while periodically repeating a forward feed period and a reverse feed period of the welding wire as one cycle (hereinafter, also referred to as a “feed control method”).

Patent Literature 1 discloses that for the purpose of preventing the generation of spatter even when a large current is passed through a wire, which is a consumable electrode, when arc welding is performed by periodically repeating forward feeding and reverse feeding of a tip of the wire, a consumable electrode type arc welding power supply that supplies a welding current to the wire serving as a consumable electrode has a control means that changes the welding current according to a periodically changing tip position of the wire when the tip of the wire is fed toward a base metal while periodically switching between a period during which the tip of the wire is fed forward and a period during which the tip of the wire is fed reverse, whereby it is also possible to reduce spatter in a high current range in which welding can be efficiently performed with high heat input.

### CITATION LIST

### Patent Literature

Patent Literature 1: JP2020-049506A

### SUMMARY OF INVENTION

### Technical Problem

In Patent Literature 1, the welding current is controlled according to the tip position of the wire or the feed speed of the wire, thereby implementing the reduction in spatter. However, the tip position of the wire is calculated based on the feed speed of the wire, and if an update cycle of a wire feed speed command (hereinafter, referred to as a “forward and reverse feed command”) to be output to the servo amplifier that controls the servo motor for forward feeding or reverse feeding the wire is slow, the number of updates by the forward and reverse feed command is limited, and an operation of the tip position of the wire cannot be obtained with high accuracy. Furthermore, a phase shift may occur between the forward and reverse feed command and the operation of the tip position of the wire, and the welding current may not be controlled at an optimum timing. As a result, there is a risk that a timing of current control is disturbed, and an effect of improving weldability is not obtained, such as an effect of reducing spatter. Although a communication speed is exemplified as a factor that slows down a command speed of a wire feed speed, updating the wire feed speed command every about 1 ms (millisecond) is limited in a configuration in which a feed command is transmitted from a control unit in a current welding power supply to a servo amplifier via a digital communication. For example, in a case in which a frequency when the forward feed period and the reverse feed period are one cycle (hereinafter, referred to as a “wire forward and reverse frequency”) is 100 Hz, if the communication speed is 1 ms, only 10 updates can be made. In order to obtain the effect of improving weldability, it is necessary to update the feed command at least at a cycle faster than 200 μs. In this case, when the wire forward and reverse frequency is 100 Hz, 50 updates can be made.

An object of the present invention is to provide a welding system, a feed control method, and a communication connection method that have a high operation accuracy for a tip position of a wire in the feed control method and can optimally control welding conditions based on at least one of the tip position or a feed speed of the wire.

### Solution to Problem

The present invention has the following configuration.

(1) A welding system in which a tip of a welding wire is fed toward a base metal while periodically repeating a forward feed period and a reverse feed period as one cycle, and at least one of welding conditions is controlled based on at least one of a tip position or a feed speed of the welding wire, the welding system including:
at least a welding control device; a welding power supply; a servo motor; and a servo amplifier configured to control the servo motor, in which
at least the servo amplifier and the welding power supply are directly or indirectly connected to each other via a digital communication,
the servo amplifier has
   a unit configured to generate a feed command for forward feeding or reverse feeding based on setting information input via the digital communication,
   a unit configured to output a control signal based on the generated feed command to the servo motor, and
   a unit configured to output a synchronization signal related to the generated feed command to the welding power supply, and
the welding power supply has a unit configured to calculate a wire position phase based on the synchronization signal.

(2) A feed control method in which a tip of a welding wire is fed toward a base metal while periodically repeating a forward feed period and a reverse feed period as one cycle, and the welding wire is welded while controlling at least one of welding conditions based on at least one of a tip position or a feed speed of the welding wire, in which
in a welding system including at least a welding control device, a welding power supply, a servo motor, and a servo amplifier that controls the servo motor, at least the servo amplifier and the welding power supply are directly or indirectly connected to each other via a digital communication,
the servo amplifier is configured to
   generate a feed command for forward feeding or reverse feeding based on setting information input via the digital communication,
   output a control signal based on the generated feed command to the servo motor, and
   output a synchronization signal related to the generated feed command to the welding power supply, and
the welding power supply is configured to calculate a wire position phase based on the synchronization signal.

(3) A communication connection method for communicating between devices constituting a welding system that controls at least one of welding conditions based on at least one of a tip position or a feed speed of the welding wire such that a tip of the welding wire is fed toward a base metal while periodically repeating a forward feed period and a reverse feed period as one cycle, in which
the welding system includes at least a welding control device, a welding power supply, a servo motor, and a servo amplifier configured to control the servo motor,
at least the servo amplifier and the welding power supply are directly or indirectly connected to each other via a digital communication,
the servo amplifier is configured to
   generate a feed command for forward feeding or reverse feeding based on setting information input via the digital communication from a device other than the servo amplifier among the devices constituting the welding system,
   output a control signal based on the generated feed command to the servo motor, and
   output a synchronization signal related to the generated feed command to the welding power supply, and
the welding power supply is configured to calculate a wire position phase based on the synchronization signal.

### Advantageous Effects of Invention

According to the present invention, a feed control method has a high operation accuracy for a tip position of a wire, and it is possible to optimally control welding conditions based on at least one of the tip position or a feed speed of the wire, thereby obtaining good weldability.

### BRIEF DESCRIPTION OF DRAWINGS

FIG. 1 is a schematic diagram illustrating a configuration example of a welding system according to the present embodiment.

FIG. 2 is a block diagram illustrating a schematic configuration related to the control of a welding power supply, a welding control device, and a servo amplifier in the present embodiment.

FIG. 3 is a graph illustrating a relation between a current setting signal, a speed phase and a position phase, and a synchronization signal.

FIG. 4 is a flowchart illustrating a task processing in gas-shielded arc welding according to a welding sequence.

### DESCRIPTION OF EMBODIMENTS

Hereinafter, embodiments of a welding system, a feed control method, and a communication connection method for gas-shielded arc welding according to the present disclosure will be described in detail with reference to the drawings.

The present embodiment is an example of a case of using a welding robot, and a welding control method according to the present disclosure is not limited to the configuration of the present embodiment. For example, an automatic welding device using a carriage may be applied instead of a welding robot body, or a portable small welding robot may be applied.

The present embodiment describes a gas metal arc welding (hereinafter, also referred to as “GMAW”) method to which a welding wire serving as a consumable electrode is applied among the gas shield arc welding. However, the welding system according to the present disclosure can be similarly applied to a system for additive manufacturing to which gas metal arc welding is applied. The present disclosure also applies to a non-consumable electrode such as TIG to which a filler wire is applied.

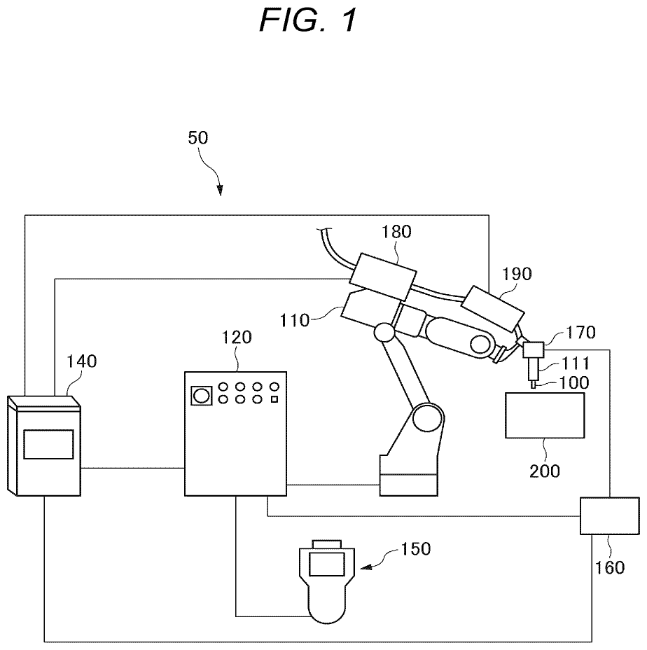

FIG. 1 is a schematic diagram illustrating a configuration example of the welding system according to the present embodiment. A welding system 50 includes a welding robot 110, a welding control device 120, a welding power supply 140, a controller 150, a servo amplifier 160, a servo motor 170, a push motor 180, and a wire buffer 190. The push motor 180 feeds the welding wire 100.

The welding power supply 140 is connected to the welding robot 110 via a positive power cable (not illustrated) so as to be able to energize the welding wire 100 serving as a consumable electrode, and is connected to a workpiece (hereinafter, also referred to as a “base metal”) 200 via a negative power cable (not illustrated). The connection is for welding with reverse polarity. When the connection is for welding with positive polarity, a polarity of the welding power supply 140 may be reversed.

The welding power supply 140 and the push motor 180 are connected to each other by a signal line, and a feed speed of the welding wire can be controlled. In the feed control of the present embodiment, the push motor 180 rotates only in a forward rotation direction, and the servo motor 170, which will be described later, is switched between the forward rotation direction and a reverse rotation direction.

The welding robot 110 includes a welding torch 111 as an end effector. The welding torch 111 has an energizing mechanism for energizing the welding wire 100, that is, a welding tip. The welding wire 100 generates an arc from a tip thereof by being energized from the welding tip, and welds the workpiece 200 to be welded by the heat. The welding tip may be generally referred to as a contact tip.

The welding torch 111 includes a shielding gas nozzle that serves as a mechanism for ejecting a shielding gas. The shielding gas is not particularly limited, and due to the characteristics of the control to be used in the present embodiment, the shielding gas may have a gas composition that takes a globule transition form, and specifically, it is preferred that the shielding gas contains at least one gas among carbon dioxide gas, nitrogen gas, hydrogen gas, and oxygen gas, which have a high potential gradient. In addition, from the viewpoint of versatility, in a case of a mixed gas with argon gas (hereinafter, also referred to as “Ar gas”), a system in which at least 10% by volume or more of carbon dioxide gas is mixed is more preferable, a system in which 90% by volume or more of carbon dioxide gas is mixed is further preferable, and it is still more preferable to use carbon dioxide gas alone. The shielding gas is supplied from a shielding gas supply device (not illustrated).

The servo motor 170 is provided near the welding torch 111. The servo amplifier 160 connected to the servo motor 170 controls the servo motor 170. In the present embodiment, the welding torch 111 is independent of the servo motor 170, and the welding torch 111 may be provided with the servo motor 170. The servo motor 170 is switched between the forward rotation direction and the reverse rotation direction based on a forward and reverse feed command to perform feed control. The servo amplifier 160 also enables a high-speed calculation processing, and has a forward and reverse feed command generating unit 161 as described later.

The wire buffer 190 is disposed between the push motor 180 and the servo motor 170. The push motor 180 feeds the wire only in the forward rotation direction, while the servo motor 170 feeds the wire in both the forward rotation direction and the reverse rotation direction, so that feed directions of the push motor 180 and the servo motor 170 may differ. This can result in a situation in which a large load is likely to be applied to the wire within a feed path. The wire buffer 190 is provided so that the feed control can also be appropriately performed in such a feeding situation, thereby preventing the buckling of the wire.

The welding wire 100 used in the present embodiment is not particularly limited. For example, either a solid wire containing no flux or a flux-cored wire containing a flux may be used. Furthermore, a material of the welding wire 100 is not limited. For example, the material may be mild steel, stainless steel, aluminum, or titanium, and a wire surface may be plated with Cu or the like. A diameter of the welding wire 100 is also not particularly limited. In the present embodiment, the diameter preferably has an upper limit of 1.6 mm and a lower limit of 0.8 mm.

In the present embodiment, a specific configuration of the workpiece 200 is not particularly limited, and welding conditions such as a joint shape, a welding position, and a groove shape are also not particularly limited. The welding control device 120 mainly controls an operation of the welding robot 110. Therefore, the welding control device 120 may be referred to as a robot controller. The welding control device 120 holds teaching data that defines an operation pattern, a welding start position, a welding end position, welding conditions, a wiving operation, and the like of the welding robot 110 in advance, and instructs the welding robot 110 on these data to control the operation of the welding robot 110. In addition, the welding control device 120 applies welding conditions such as a welding current, a welding voltage, and a feed speed during a welding operation to the welding power supply 140 in accordance with the teaching data.

As illustrated in FIG. 1, the welding system 50 of the present embodiment has a configuration in which the welding control device 120 is independent of the welding power supply 140, and may have a configuration in which the welding control device 120 is provided in the welding power supply 140.

The controller 150 is connected to the welding control device 120, creates or displays a program for operating the welding robot 110, and inputs the teaching data. Information input to the controller 150 by a user is given to the welding control device 120. The controller 150 may also have a function of manually operating the welding robot 110. The connection between the controller 150 and the welding control device 120 may be wired or wireless.

The welding power supply 140 generates an arc between the welding wire 100 and the workpiece 200 by supplying electric power to the welding wire 100 and the workpiece 200 according to a command from the welding control device 120. In addition, the welding power supply 140 outputs a control signal for the push motor 180 according to a command from the welding control device 120.

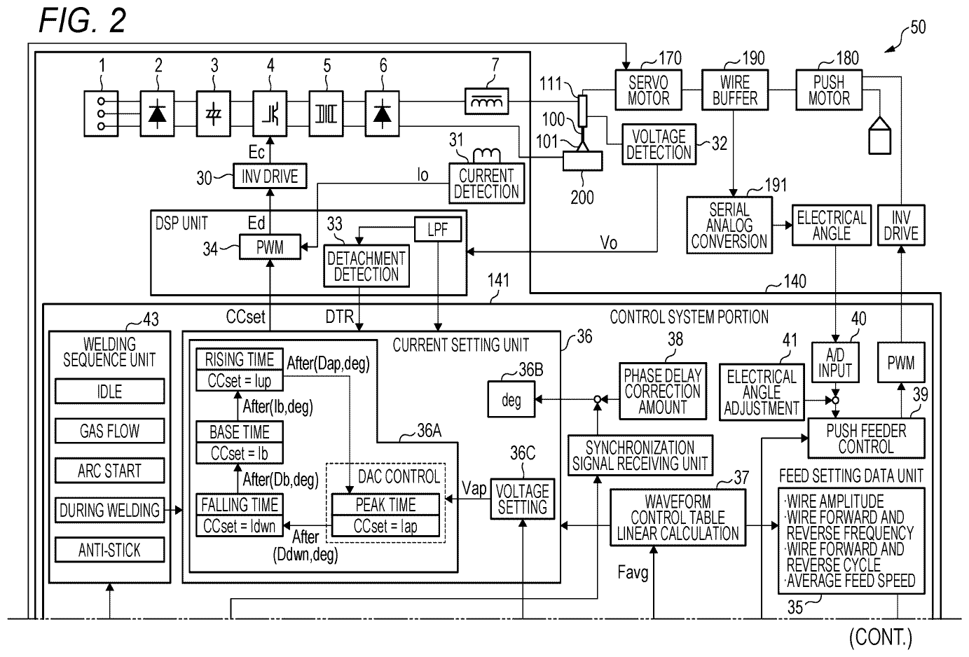

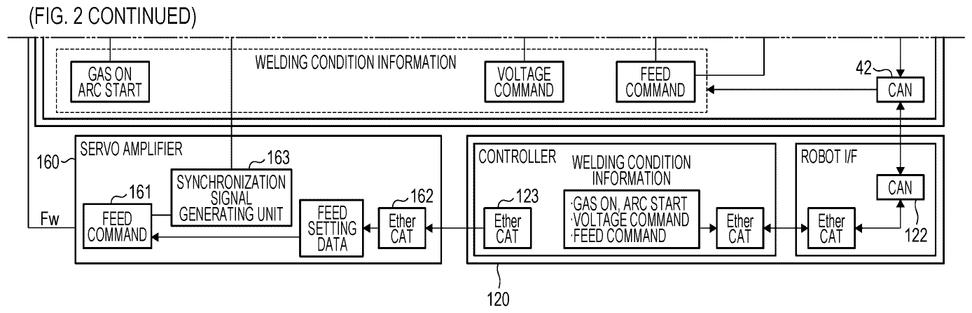

Next, a functional configuration of the welding system 50 according to the present embodiment will be described in detail with reference to FIG. 2. FIG. 2 is a block diagram illustrating a schematic configuration related to the control of the welding power supply 140, the welding control device 120, and the servo amplifier 160 in the present embodiment.

The welding power supply 140 is connected to the welding control device 120 via a digital communication, and the welding control device 120 is connected to the servo amplifier 160 via the digital communication. That is, the servo amplifier 160, the welding control device 120, and the welding power supply 140, which are connected via the digital communication, are connected to one another in this order in a line configuration. This can be interpreted as a state in which the servo amplifier 160 and the welding power supply 140 are indirectly connected to each other via the digital communication. The servo amplifier 160, the welding power supply 140, and the welding control device 120 may be connected to one another in this order in a line configuration. This can be interpreted as a state in which the servo amplifier 160 and the welding power supply 140 are directly connected to each other via the digital communication.

In the present embodiment, the welding power supply 140 and the welding control device 120 are in communication with each other via a controller Area Network (CAN), which is one of industrial field networks, the welding control device 120 and the servo amplifier 160 are in communication with each other via Ethernet for Control Automation Technology (EtherCAT) (registered trademark), which is one of the industrial field networks, and the communication is not limited thereto.

### (Functional Configuration of Welding Power Supply)

A control system portion 141 of the welding power supply 140 is executed, for example, through the execution of a program by the welding control device 120 or a computer (not illustrated). The control system portion 141 of the welding power supply 140 includes a current setting unit 36. The current setting unit 36 according to the present embodiment has a function of setting various current values that define a welding current flowing through the welding wire 100. The current setting unit 36 includes a target current setting unit 36A, a wire tip position conversion unit 36B, and a voltage setting unit 36C. The target current setting unit 36A has a function of setting a period start time and a period end time for each period of a peak period Dap, a falling period Ddwn, a base period Db, and a rising period Dup related to current control. The wire tip position conversion unit 36B has a function of obtaining information on a tip position of the welding wire 100.

Various condition settings for each period of the peak period Dap, the falling period Ddwn, the base period Db, and the rising period Dup related to a current non-inhibition period TIP (sum of the Dup period and the Dap period in the present embodiment) and a current inhibition period TIB (sum of the Ddwn period and the Db period in the present embodiment) may be determined by a waveform control table linear calculation unit 37 based on a waveform control table prepared in advance. The various condition settings referred to here mean the setting of conditions such as current value, time, or phase in the present embodiment.

The welding current indicates a pulse waveform in which welding currents during the current non-inhibition period TIP and the current inhibition period TIB are alternately repeated based on a phase related to a wire tip position (hereinafter, referred to as a “wire position phase” or a “position phase”). In the present embodiment, a timing of the peak period Dap, the falling period Ddwn, the base period Db, and the rising period Dup is controlled based on the wire position phase of 0° to 360° (0 to 2π) at which a case in which the wire tip position is closest to a tip side is set to 0°, and a case in which the wire tip position is closest to a base metal side is set to 180°.

A set current value lap during the peak period Dap (hereinafter, also referred to as a “peak current Tap”) in the current non-inhibition period TIP calculated by the waveform control table linear calculation unit 37 and a set current value Ib during the base section Db (hereinafter, also referred to as a “base current Ib”) in the current inhibition period TIB are set in the current setting unit 36 based on a setting value of the average feed speed Favg in welding condition information stored in the control system portion 141. Although this is merely an example, a sum of a peak current command value Ip and an operation amount Mn from the waveform control table may be used as the peak current Iap. In this case, Iap=Ip+Mn. The operation amount Mn is calculated based on a voltage setting value Vap and a value Vo of a voltage detection signal.

In the present embodiment, the welding current is basically controlled by two values of the peak current lap and the base current Ib. Therefore, the start time of the base period Db represents a time when the base current Ib starts, that is, a base current start time. In addition, a time when the current inhibition period Db ends represents a time when the base current Ib ends, that is, a base current end time. The time when the base period Db starts, the time when the base period Db ends, a period (time) of the falling period Ddwn, and a period (time) of the falling period Ddwn are calculated in the waveform control table linear calculation unit 37. The time when the peak period Dap starts may be expressed as a peak current start time, and the time when the peak period Dap ends may be expressed as a peak current end time.

Various start times, end times, and the like described above are described with reference to time. However, processing may be performed by converting a value of the wire position phase to time or cycle cyc based on the value of the wire position phase. That is, the values of the wire position phase, the time, and the cycle cyc can be mutually converted, and thus the control may be performed based on any of the values.

The wire tip position conversion unit 36B determines the wire tip position based on a phase synchronization signal and a phase delay correction amount signal from the servo amplifier 160. In the present embodiment, the wire tip position may be expressed using an angle (0 to 2π) as the wire position phase as described above.

The phase delay correction amount signal is output from a phase delay correction unit 38. The phase delay correction unit 38 includes a database (not illustrated). The database stores data in which a difference between periodic setting information and an operation signal of an actual forward and reverse feed operation of the servo motor 170 is calculated in advance for each of various welding conditions. For example, when the welding condition is a wire forward and reverse frequency, a phase delay correction amount is determined based on the database according to a value of the wire forward and reverse frequency to be used, and is output from the phase delay correction unit 38 as the phase delay correction amount signal.

A power supply main circuit of the welding power supply 140 includes a three-phase alternating-current power supply (hereinafter, also referred to as an “alternating-current power supply”) 1, a primary-side rectifier 2, a smoothing capacitor 3, a switching element 4, a transformer 5, a secondary-side rectifier 6, and a reactor 7.

An alternating-current power input from the alternating-current power supply 1 is full-wave rectified by the primary-side rectifier 2 and further smoothed by the smoothing capacitor 3 to be converted into a direct-current power. Next, the direct-current power is converted into a high-frequency alternating-current power by inverter control using the switching element 4, and then converted into a secondary-side power via the transformer 5. An alternating-current output of the transformer 5 is full-wave rectified by the secondary-side rectifier 6 and further smoothed by the reactor 7. An output current of the reactor 7 is supplied to a welding tip as an output from the power supply main circuit, and the welding wire 100 serving as a consumable electrode is energized.

The welding wire 100 is fed by the push motor 180, and generates an arc between the welding wire 100 and a base metal 200. A forward feed period during which the tip of the welding wire 100 is moved toward the base metal 200 is referred to as a forward feed period TP. A reverse feed period during which the tip of the welding wire 100 is moved in a direction opposite to a direction in which the base metal 200 is located is referred to as a reverse feed period TN. In the present embodiment, a feed motor periodically feeds the welding wire 100 with the forward feed period TP and the reverse feed period TN as one cycle. In addition, the tip of the welding wire generally refers to a wire tip when the presence of a droplet hanging down from the wire tip is ignored. That is, the wire melted by the arc is considered to be transferred to the base metal 200 immediately.

The feeding of the welding wire 100 made by the push motor 180 is controlled by a control signal based on the push feeder control unit 39. An average value of the feed speed is substantially the same as the melting speed. In the present embodiment, the feeding of the welding wire 100 made by the push motor 180 is also controlled by the welding power supply 140.

The push feeder control unit 39 performs control according to a state of the wire buffer 190. In the present embodiment, in order to prevent a large load from being applied to the wire in the feed path between the push motor 180 and the servo motor 170, the wire buffer 190 is provided with a slack portion of the wire (gap portion that escapes when the wire is loosened due to the influence of feeding between the motors), and a buffer amount of the wire is detected as a rotation angle by an absolute encoder that is a sensor built in the wire buffer 190. The detected value is converted into an analog signal by a serial analog conversion unit 191, and an electrical angle is calculated by an electrical angle calculation unit. The calculated electrical angle is input to an A/D input unit 40 of the welding power supply.

A differential signal obtained by calculating a difference between the electrical angle from the A/D input unit 40 and a reference value of the electrical angle preset in an electrical angle adjustment unit 41 is input to the push feeder control unit 39. The push feeder control unit 39 performs interference control to prevent a large load from being applied to a feed system by controlling the push motor 180 so as to obtain an appropriate wire buffer amount based on the differential signal. In the present embodiment, the interference control is performed, and the present invention is not limited thereto. In the present embodiment, the absolute encoder built in the wire buffer 190 is used, and the present invention is not limited thereto. For example, a rotation angle sensor may be used, and in this case, no serial analog conversion unit 191 may be provided.

A voltage setting signal Vap, which is a target value of a voltage applied between the welding tip and the base metal 200, is given from the voltage setting unit 36C to the current setting unit 36.

On the other hand, the voltage detection signal Vo is a measured value. In the present embodiment, the voltage detection signal Vo passes through a low-pass filter LPF, and is input to the current setting unit 36 together with a detachment detection signal DTR to be described later via the detachment detection unit 33 to be described later. A voltage comparison unit may be provided to amplify a difference between the voltage setting signal Vap and the voltage detection signal Vo and output the amplified difference to the current setting unit 36 as a voltage error amplification signal.

The current setting unit 36 controls a welding current during the peak period Dap such that a length of the arc (hereinafter, also referred to as an “arc length”) is constant. The current setting unit 36 determines and sets at least a peak period, a rising period, a base period, and a rising period based on the voltage setting signal Vap and the voltage detection signal Vo. The value of the peak current Ip and the value of the base current Ib may be reset. A current setting signal CCset corresponding to the set period or value is output to a current error amplification unit (PWM) 34.

The current error amplification unit 34 amplifies a difference between the current setting signal CCset given as a target value and a current detection signal Io detected by a current detection unit 31, and outputs the amplified difference to an inverter drive unit 30 as a current error amplification signal Ed. The inverter drive unit 30 corrects a drive signal Ec of the switching element 4 using the current error amplification signal Ed.

The current setting unit 36 also receives the detachment detection signal DTR, which is a signal for detecting the detachment of a droplet from the tip of the welding wire 100. The detachment detection signal DTR is output from the detachment detection unit 33. The detachment detection unit 33 monitors a change in the voltage detection signal Vo output from the voltage detection unit 32, and detects the detachment of a droplet from the welding wire 100 based on the change. The detachment detection unit 33 is an example of a detection means.

The detachment detection unit 33 detects the detachment of a droplet by, for example, comparing a value obtained by differentiating or second-order differentiating the voltage detection signal Vo passed through the LPF with a predetermined threshold value for detection. The threshold value for detection is stored in advance in a storage unit (not illustrated). The detachment detection unit 33 may generate the detachment detection signal DTR based on a change in a resistance value calculated based on the voltage detection signal Vo and the current detection signal Io, which are measured values.

The waveform control table linear calculation unit 37 receives the average feed speed Favg of the welding wire 100 to be fed. The average feed speed Favg is stored in advance in a feed setting data unit 35. The feed setting data unit 35 is provided in the welding power supply 140 in the present embodiment, various types of information related to the feed setting may be stored in the welding control device 120, and the various types of information may be output from the welding control device 120 to the welding power supply 140.

The waveform control table linear calculation unit 37 determines values of the peak current Ip, the base current Ib, the time when the base current Ib starts, the time when the base current Ib ends, and the like based on the given average feed speed Favg, and inputs the values to the current setting unit 36. As described above, the values of the wire position phase, the time, and the cycle cyc can be converted into one another, and thus a setting value of a base start phase and the like may be converted into the value of the time or the cycle cyc, and the converted value may be output to the current setting unit 36.

In the present embodiment, the average feed speed Favg is input to the waveform control table linear calculation unit 37, a value related to the average feed speed Favg may be input to the waveform control table linear calculation unit 37 as a setting value, and the waveform control table linear calculation unit 37 may replace the setting value with the average feed speed Favg. For example, in a case in which a database of the average feed speed Favg and an average current value at which optimal welding can be performed at the average feed speed Favg is stored in the storage unit (not illustrated), the average current value may be used as a setting value, and the setting value may be replaced with the average feed speed Favg.

The feed setting data unit 35 may store setting values of the average feed speed Favg, a wire amplitude Wf, a wire forward and reverse frequency Sf, a wire forward and reverse cycle Tf, and the like. The wire amplitude Wf, the wire forward and reverse frequency Sf, and the wire forward and reverse cycle Tf may be determined based on the input average feed speed Favg. In addition, the feed setting data unit 35 may store other setting values as feed setting data.

In the present embodiment, a period during which a feed speed is higher than the average feed speed Favg is referred to as a forward feed period, a period during which a feed speed is lower than the average feed speed Favg is referred to as a reverse feed period, and the feed in which the forward feed period and the reverse feed period alternately appear (hereinafter, referred to as “amplitude feed”) is obtained. The period during which the feed speed is lower than the average feed speed Favg refers to a period during which a feed speed is less than the average feed speed Favg, the feed speed including a negative feed speed, that is, a speed at which the wire tip moves in the direction opposite to the position of the base metal 200. The wire amplitude Wf gives a change width with respect to the average feed speed Favg, and the wire forward and reverse cycle Tf gives a time of change in the wire amplitude, which is a repetition unit. The wire forward and reverse frequency Sf is a reciprocal of the wire forward and reverse cycle Tf.

The average feed speed Favg, the wire amplitude Wf, the wire forward and reverse frequency Sf, and the wire forward and reverse cycle Tf stored in the feed setting data unit 35 are input from a digital communication unit 42 to a digital communication unit 122 of the welding control device 120. In the present embodiment, the communication of these feed setting data is performed via a CAN communication.

The welding sequence unit 43 processes each task in order of idle, gas flow, arc start, during welding, and anti-stick based on teaching data. Among these tasks, the control is performed mainly by the current setting unit 36 in the task of “during welding”. In FIG. 2, the welding condition information held by the welding control device 120 is indicated by a broken line in the welding power supply 140 for the sake of convenience.

### (Functional Configuration of Welding Control Device)

As described above, the digital communication unit 122 of the welding control device 120 receives the feed setting data such as the average feed speed Favg, the wire amplitude Wf, the wire forward and reverse frequency Sf, and the wire forward and reverse cycle Tf from the feed setting data unit 35 of the welding power supply 140 via the CAN communication. The welding control device 120 includes a digital communication unit 123 for outputting the feed setting data to a digital communication unit 162 of the servo amplifier 160. In the present embodiment, the digital communication unit 123 of the welding control device 120 and the digital communication unit 162 of the servo amplifier 160 are connected to each other via an EtherCAT (registered trademark) communication.

### (Functional Configuration of Servo Amplifier)

The digital communication unit 162 of the servo amplifier 160 receives the feed setting data such as the average feed speed Favg, the wire amplitude Wf, the wire forward and reverse frequency Sf, and the wire forward and reverse cycle Tf via the EtherCAT (registered trademark) communication. The forward and reverse feed command generating unit 161 of the servo amplifier 160 generates a feed command for forward feeding or reverse feeding based on setting information input via the digital communication, that is, the feed setting data. The forward and reverse feed command generating unit 161 calculates an amplitude feed speed Ff based on the wire amplitude Wf and the wire forward and reverse cycle Tf, and outputs the feed speed command signal Fw to the servo motor 170 based on the amplitude feed speed Ff and the average feed speed Favg.

In the present embodiment, the feed speed command signal Fw is represented by the following equation.

$$Fw = Ff + Favg \qquad ( A )$$

The forward and reverse feed command generating unit 161 may detect at which wire position phase of the amplitude feed the detachment has occurred based on the detachment detection signal DTR given from the detachment detection unit 33. The feed speed command signal Fw represented by Equation (A) is limited to a case in which the detachment of a droplet from the tip of the welding wire 100 is detected within an assumed period. When no detachment of a droplet is detected within the assumed period, the forward and reverse feed command generating unit 161 may switch the feed speed command signal Fw to feed control at a constant speed. For example, the forward and reverse feed command generating unit 161 switches the feed speed command signal Fw to feeding at the average feed speed Favg. The switching from the feeding at the average feed speed Favg to the feed control represented by Equation (A) is determined according to a timing at which the detachment of a droplet is detected.

The servo amplifier 160 performs inverter control of the servo motor 170 based on the feed speed command signal Fw. In addition, a synchronization signal generating unit 163 of the servo amplifier 160 outputs a phase synchronization signal to the welding power supply 140. The phase synchronization signal is generated based on the feed speed command signal Fw.

Both the welding power supply 140 and the synchronization signal generating unit 163 of the servo amplifier 160 may be connected to each other at least via an analog input and output. In this case, a synchronization signal is input to the welding power supply 140 from the servo amplifier 160 via the analog input and output. By transmitting the feed setting data such as the average feed speed Favg, the wire amplitude Wf, the wire forward and reverse frequency Sf, and the wire forward and reverse cycle Tf via the digital communication, while transmitting the synchronization signal via an analog communication, it is possible to efficiently use the digital communication and the analog communication depending on an application.

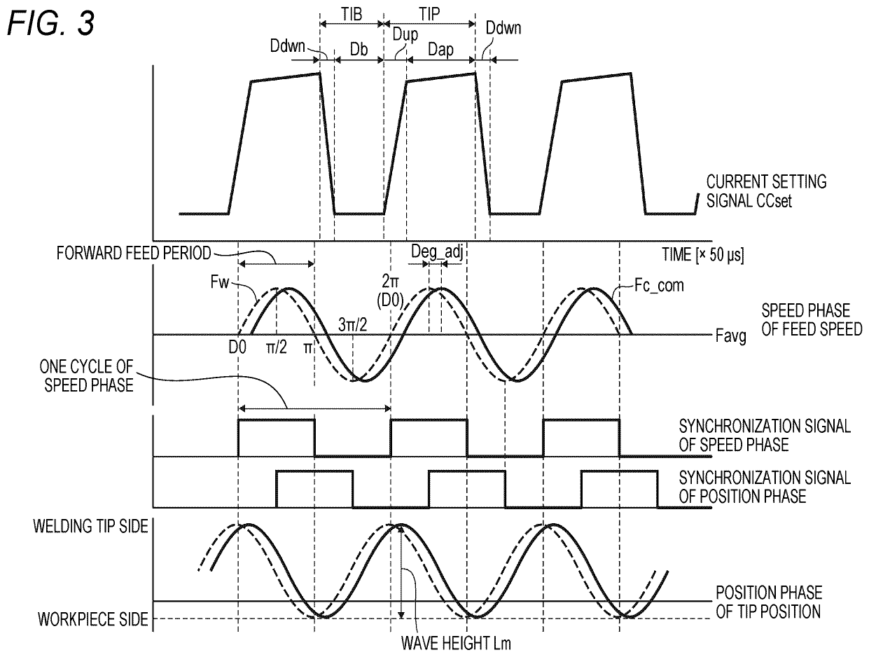

FIG. 3 is a graph illustrating a relation between the current setting signal CCset, a speed phase and a position phase, and the synchronization signal. A wavy line indicated by a broken line in the speed phase of the feed speed represents the feed speed indicated by the feed speed command signal Fw. A wavy line indicated by a solid line in the speed phase of the feed speed represents an actual feed speed Fc_com.

In the present embodiment, the phase synchronization signal is at least one of the synchronization signal of the wire position phase and the synchronization signal of the speed phase of the feed speed (hereinafter, also simply referred to as a “speed phase”). As illustrated in FIG. 3, the synchronization signal of the speed phase is a synchronization signal in which the forward feed period (position from 0 to π) is set to ON and the reverse feed period (position from π to 2π) is set to OFF. On the other hand, the synchronization signal of the position phase is a synchronization signal in which a period (position of 0.5 π to 1.5 π) during which the tip of the wire when the wire is fed forward and reverse approaches a base metal 200 side from a center position (position at a wave height Lm/2) of the wire amplitude wf is set to ON, and a period (position of 1.5 π to 0.5 π) during which the tip of the wire approaches the tip side from the center position of the wire amplitude is set to OFF. In the present embodiment, the wave height Lm is a difference (mm) between a position at which the wire tip position is closest to the tip side and a position at which the wire tip position is closest to the base metal side, and when a unit of the wire amplitude wf which is the setting value is set to “mm”, the wave height Lm and the wire amplitude wf are the same.

Based on the phase synchronization signal and the above-described phase delay correction amount, the wire tip position conversion unit 36B of the welding power supply 140 determines the wire position phase of the welding wire 100. The current setting unit 36 sets various current values that define the welding current flowing through the welding wire 100 based on the determined wire position phase. That is, the welding conditions are controlled by determining the wire position phase based on the database and the synchronization signal. In the present embodiment, the welding conditions are controlled by correcting a timing of the waveform control of the welding current. In the present embodiment, the phase delay correction amount corresponds to Deg-adj illustrated in FIG. 3, and the wire position phase is determined based on the phase synchronization signal obtained by correcting a Deg-adj phase.

The welding conditions may be controlled without providing a database in the phase delay correction unit 38. In order to implement the control, the phase delay correction amount is calculated by reading an operation cycle of the servo motor 170 with an encoder or the like (not illustrated). That is, the servo amplifier 160 has an encoder which is a means for inputting the setting information and the operation signal of the servo motor 170, for example, a phase signal of a forward and reverse feed operation, and calculating a difference between the feed command generated by the servo amplifier 160 and the operation signal of the servo motor 170, for example, a phase shift. The welding conditions may be controlled in the welding power supply 140 by determining the wire position phase based on the difference and the synchronization signal. The welding conditions may be controlled by correcting the timing of the waveform control of the welding current.

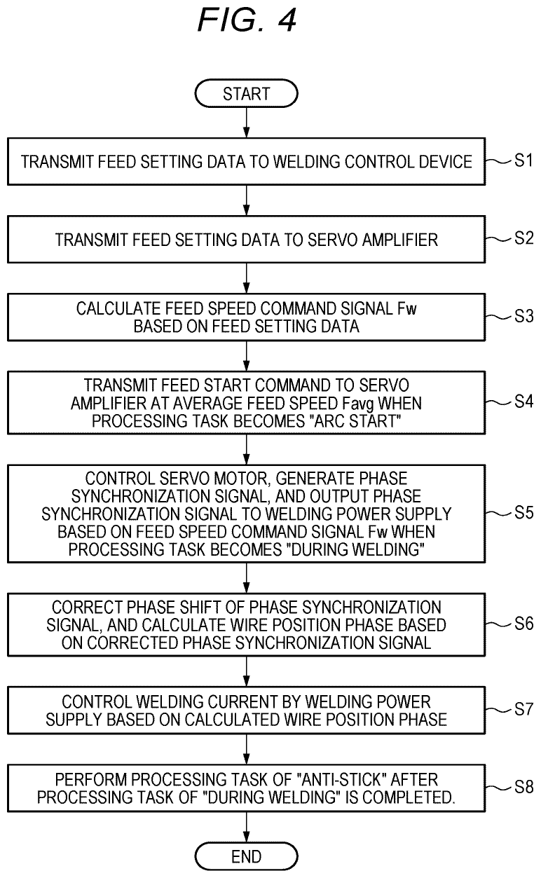

FIG. 4 is a flowchart illustrating a task processing in the gas-shielded arc welding according to a welding sequence.

First, the feed setting data is stored in advance in the feed setting data unit 35 of the welding power supply 140. The feed setting data includes the average feed speed Favg, the wire amplitude Wf, the wire forward and reverse frequency Sf, the wire forward and reverse cycle Tf, and the like.

The welding power supply 140 transmits the feed setting data to the welding control device 120 (S1). The transmission may be performed via the CAN communication or the EtherCAT (registered trademark) communication.

The welding control device 120 transmits the feed setting data to the servo amplifier 160 (S2). The transmission may be performed via the EtherCAT (registered trademark) communication.

The forward and reverse feed command generating unit 161 of the servo amplifier 160 calculates the feed speed command signal Fw, which is a basis for driving and controlling the servo motor 170, based on the acquired feed setting data, that is, the average feed speed Favg, the wire amplitude Wf, the wire forward and reverse frequency Sf, and the wire forward and reverse cycle Tf (S3).

In the present embodiment, the welding power supply 140 is connected to the welding control device 120 via the digital communication, and the welding control device 120 is connected to the servo amplifier 160 via the digital communication, and thus the above-described steps S1 and S2 are processed. The present invention is not limited thereto, and processing may be performed according to a network connection form of each device. For example, a network connection form in which the servo amplifier 160 and the welding power supply 140 are connected to each other via the digital communication, and the welding power supply 140 and the welding control device 120 are connected to each other via the digital communication is also conceivable. In this case, the feed setting data such as the average feed speed Favg, the wire amplitude Wf, the wire forward and reverse frequency Sf, and the wire forward and reverse cycle Tf may be stored in any one of the welding power supply 140 or the welding control device 120. When the feed setting data is stored in the welding power supply 140, the feed setting data is transmitted from the welding power supply 140 to the servo amplifier 160 via the EtherCAT (registered trademark) communication. When the feed setting data is stored in the welding control device 120, for example, the feed setting data may be transmitted from the welding control device 120 to the welding power supply 140 via the CAN communication, and the feed setting data may be transmitted from the welding power supply 140 to the servo amplifier 160 via the EtherCAT (registered trademark) communication.

In step S4, the processing of the welding sequence unit 43 is started. The tasks of “idle”, “gas flow”, and “arc start” are tasks that are generally performed in the gas-shielded arc welding, and thus the detailed description thereof will be omitted.

In step S5, the servo motor 170 is controlled based on the feed speed command signal Fw after a predetermined time has elapsed after the task of the welding sequence unit 43 becomes “during welding”. In addition, the synchronization signal generating unit 163 generates at least one phase synchronization signal of the synchronization signal of the speed phase or the synchronization signal of the position phase, based on the feed speed command signal Fw, and outputs the generated synchronization signal to the welding power supply 140.

In step S6, the welding power supply 140 corrects the phase shift of the phase synchronization signal based on the phase delay correction amount calculated by the phase delay correction unit 38 of the welding power supply 140. The welding power supply 140 inputs the corrected phase synchronization signal to the wire tip position conversion unit 36B, and calculates the wire position phase of the welding wire 100 in real time. Although it is preferred to correct the phase shift from the viewpoint of an operation accuracy of the tip position of the wire, the welding power supply 140 may input the phase synchronization signal directly to the wire tip position conversion unit 36B without correcting the phase synchronization signal.

The welding current is controlled by the welding power supply 140 based on the wire position phase of the welding wire 100 calculated in real time in step S6 (step S7). In the present embodiment, the waveform of the welding current is controlled as the control of the welding conditions. However, the control of the welding conditions in step S7 is not limited to controlling the waveform of the welding current. For example, a waveform of an arc voltage, a travel speed, or the like among the welding conditions may be controlled. For example, a plurality of welding conditions may be controlled such as controlling the waveform of the welding current and the waveform of the arc voltage.

In step S8, while the task of the welding sequence unit 43 is “during welding”, the process of steps S5 to S7 is continued, and when the task of “during welding” is completed, the “anti-stick” is controlled, and the welding is completed. The task of “anti-stick” is a task that is generally performed in the gas-shielded arc welding, and thus the detailed description thereof will be omitted.

The above-described steps S1 to S8 enable smooth data transmission via the digital communication. By generating a signal of the forward and reverse feed command (feed speed command signal Fw) in the servo amplifier 160 that can perform a high-speed calculation processing, a tip operation of the wire can be grasped with high accuracy.

A synchronization signal is output from the servo amplifier 160 to the welding power supply 140, and the welding conditions such as the welding current are controlled based on the synchronization signal, thereby enabling more advanced control.

Therefore, in the welding system 50 of the present disclosure, the feed control method has a high operation accuracy for the tip position of the wire, and can optimally implement control such as the control of the waveform of the welding current based on at least one of the tip position or the feed speed of the wire.

The present invention is not limited to the embodiments described above, and combinations of the respective configurations of the embodiments and changes and applications made by those skilled in the art based on the description of the specification and well-known techniques are also intended for the present invention and are included in the scope of protection.

As described above, the present description discloses the following matters.

(1) A welding system in which a tip of a welding wire is fed toward a base metal while periodically repeating a forward feed period and a reverse feed period as one cycle, and at least one of welding conditions is controlled based on at least one of a tip position or a feed speed of the welding wire, the welding system including:
at least a welding control device; a welding power supply; a servo motor; and a servo amplifier configured to control the servo motor, in which
at least the servo amplifier and the welding power supply are directly or indirectly connected to each other via a digital communication,
the servo amplifier has
   a unit configured to generate a feed command for forward feeding or reverse feeding based on setting information input via the digital communication,
   a unit configured to output a control signal based on the generated feed command to the servo motor, and
   a unit configured to output a synchronization signal related to the generated feed command to the welding power supply, and
the welding power supply has a unit configured to calculate a wire position phase based on the synchronization signal.

According to the welding system, the feed control method has a high operation accuracy for the tip position of the wire, and can optimally implement the control of the welding conditions performed based on at least one of the tip position or the feed speed of the wire.

(2) The welding system according to (1), in which the synchronization signal is based on at least one of the wire position phase or a speed phase of the feed speed.

According to the welding system, it is possible to synchronize the servo motor with the welding power supply based on the wire position phase or the speed phase of the feed speed.

(3) The welding system according to (1) or (2), in which
the servo amplifier has a unit configured to input the setting information and an operation signal of the servo motor, and calculate a difference between the generated feed command and the operation signal of the servo motor, and
the welding power supply has a unit configured to control the welding conditions based on the difference and the synchronization signal.

According to the welding system, the servo amplifier can perform a high-speed calculation processing, and thus it is possible to accurately detect a shift between the feed command based on the setting information and an actual operation of the servo motor, and to perform a shift correction with high accuracy.

(4) The welding system according to any one of (1) to (3), in which
the welding power supply has
   a database including data obtained by calculating in advance a difference between the setting information and the operation signal of the servo motor, and
   a unit configured to control the welding conditions based on the database and the synchronization signal.

According to the welding system, the welding conditions such as the timing of the waveform control of the welding current controlled by the welding power supply can be appropriately synchronized with the servo motor for controlling the feeding of the wire.

(5) The welding system according to any one of (1) to (4), in which the setting information includes at least one setting value of an average feed speed, a wire amplitude, a wire forward and reverse frequency, and a wire forward and reverse cycle.

According to the welding system, the servo motor can generate a feed command for forward feeding or reverse feeding based on the setting value.

(6) The welding system according to any one of (1) to (5), in which
the welding power supply and the servo amplifier are connected to each other at least via an analog input and output, and
at least the synchronization signal is input to the welding power supply from the servo amplifier via the analog input and output.

According to the welding system, by transmitting the setting information via the digital communication, while transmitting the synchronization signal via an analog communication, it is possible to efficiently use the digital communication and the analog communication depending on an application.

(7) The welding system according to any one of (1) to (6), further including:
a wire buffer device; and a push motor, in which
the wire buffer device has a sensor that detects a buffer amount of the wire, and
the welding power supply has a unit configured to control the push motor based on the input buffer amount.

According to the welding system, it is possible to prevent a large load from being applied to the wire in a feed path between the push motor and the servo motor.

(8) A feed control method in which a tip of a welding wire is fed toward a base metal while periodically repeating a forward feed period and a reverse feed period as one cycle, and the welding wire is welded while controlling at least one of welding conditions based on at least one of a tip position or a feed speed of the welding wire, in which
in a welding system including at least a welding control device, a welding power supply, a servo motor, and a servo amplifier that controls the servo motor, at least the servo amplifier and the welding power supply are directly or indirectly connected to each other via a digital communication,
the servo amplifier is configured to
   generate a feed command for forward feeding or reverse feeding based on setting information input via the digital communication,
   output a control signal based on the generated feed command to the servo motor, and
   output a synchronization signal related to the generated feed command to the welding power supply, and
the welding power supply is configured to calculate a wire position phase based on the synchronization signal.

According to the feed control method, the feed control method has a high operation accuracy for the tip position of the wire, and can optimally implement the control of the welding conditions performed based on at least one of the tip position or the feed speed of the wire.

(9) A communication connection method for communicating between devices constituting a welding system that controls at least one of welding conditions based on at least one of a tip position or a feed speed of the welding wire such that a tip of the welding wire is fed toward a base metal while periodically repeating a forward feed period and a reverse feed period as one cycle, in which
the welding system includes at least a welding control device, a welding power supply, a servo motor, and a servo amplifier configured to control the servo motor,
at least the servo amplifier and the welding power supply are directly or indirectly connected to each other via a digital communication,
the servo amplifier is configured to
   generate a feed command for forward feeding or reverse feeding based on setting information input via the digital communication from a device other than the servo amplifier among the devices constituting the welding system,
   output a control signal based on the generated feed command to the servo motor, and
   output a synchronization signal related to the generated feed command to the welding power supply, and
the welding power supply is configured to calculate a wire position phase based on the synchronization signal.

According to the communication connection method, the feed control method has a high operation accuracy for the tip position of the wire, and can optimally implement the control of the welding conditions performed based on at least one of the tip position or the feed speed of the wire.

(10) The communication connection method according to (9), in which
the digital communication is a digital communication connected via an industrial field network, and
the servo amplifier, the welding control device, and the welding power supply are connected to one another in this order in a line configuration, or the servo amplifier, the welding power supply, and the welding control device are connected to one another in this order in a line configuration.

According to the communication connection method, the setting information can be smoothly transmitted between the devices constituting the welding system by utilizing the industrial field network.

Although various embodiments are described above, it is needless to say that the present invention is not limited to these embodiments. It is apparent that those skilled in the art can conceive of various modifications or alterations within the scope described in the claims, and it is understood that such modifications or alterations naturally fall within the technical scope of the present invention. In addition, the respective constituent elements in the above-described embodiments may be freely combined without departing from the gist of the invention.

The present application is based on a Japanese Patent Application (Patent Application No. 2022-192369) filed on Nov. 30, 2022, contents of which are incorporated herein by reference.

### REFERENCE SIGNS LIST

1: three-phase alternating-current power supply
2: primary-side rectifier
3: smoothing capacitor
4: switching element
5: transformer
6: secondary-side rectifier
7: reactor
30: inverter drive unit
31: current detection unit
32: voltage detection unit
33: detachment detection unit
34: current error amplification unit
35: feed setting data unit
36: current setting unit
36A: target current setting unit
36B: wire tip position conversion unit
36C: voltage setting unit
37: waveform control table linear calculation unit
38: phase delay correction unit
39: push feeder control unit
40: A/D input unit
41: electrical angle adjustment unit
42: digital communication unit
43: welding sequence unit
50: welding system
100: welding wire
110: welding robot
111: welding torch
120: welding control device
122: digital communication unit
123: digital communication unit
140: welding power supply
141: control system portion
150: controller
160: servo amplifier
161: forward and reverse feed command generating unit
162: digital communication unit
163: synchronization signal generating unit
170: servo motor
180: push motor
190: wire buffer
191: serial analog conversion unit
200: workpiece

1. A welding system in which a tip of a welding wire is fed toward a base metal while periodically repeating a forward feed period and a reverse feed period as one cycle, and at least one of welding conditions is controlled based on at least one of a tip position or a feed speed of the welding wire, the welding system comprising:
at least a welding control device; a welding power supply; a servo motor; and a servo amplifier configured to control the servo motor, wherein
at least the servo amplifier and the welding power supply are directly or indirectly connected to each other via a digital communication,
the servo amplifier has a forward and reverse feed command generating unit configured to generate a feed command for forward feeding or reverse feeding based on setting information input via the digital communication,
the servo amplifier is configured to output a control signal based on the generated feed command to the servo motor, and
output a synchronization signal related to the generated feed command to the welding power supply, and
the welding power supply is configured to calculate a wire position phase based on the synchronization signal.

2. The welding system according to claim 1, wherein
the synchronization signal is based on at least one of the wire position phase or a speed phase of the feed speed.

3. The welding system according to claim 2, wherein
the servo amplifier is configured to input the setting information and an operation signal of the servo motor, and calculate a difference between the generated feed command and the operation signal of the servo motor, and
the welding power supply is configured to control the welding conditions based on the difference and the synchronization signal.

4. The welding system according to claim 2, wherein
the welding power supply has a database including data obtained by calculating in advance a difference between the setting information and the operation signal of the servo motor, and
the welding power supply is configured to control the welding conditions based on the database and the synchronization signal.

5. The welding system according to claim 1, wherein
the setting information includes at least one setting value of an average feed speed, a wire amplitude, a wire forward and reverse frequency, and a wire forward and reverse cycle.

6. The welding system according to claim 1, wherein
the welding power supply and the servo amplifier are connected to each other at least via an analog input and output, and
at least the synchronization signal is input to the welding power supply from the servo amplifier via the analog input and output.

7. The welding system according to claim 1, further comprising:
a wire buffer device; and a push motor, wherein
the wire buffer device has a sensor that detects a buffer amount of the wire, and
the welding power supply is configured to control the push motor based on the input buffer amount.

8. A feed control method in which a tip of a welding wire is fed toward a base metal while periodically repeating a forward feed period and a reverse feed period as one cycle, and the welding wire is welded while controlling at least one of welding conditions based on at least one of a tip position or a feed speed of the welding wire, wherein
in a welding system including at least a welding control device, a welding power supply, a servo motor, and a servo amplifier that controls the servo motor, at least the servo amplifier and the welding power supply are directly or indirectly connected to each other via a digital communication,
the servo amplifier is configured to
generate a feed command for forward feeding or reverse feeding based on setting information input via the digital communication,
output a control signal based on the generated feed command to the servo motor, and
output a synchronization signal related to the generated feed command to the welding power supply, and
the welding power supply is configured to calculate a wire position phase based on the synchronization signal.

9. A communication connection method for communicating between devices constituting a welding system that controls at least one of welding conditions based on at least one of a tip position or a feed speed of a welding wire such that a tip of the welding wire is fed toward a base metal while periodically repeating a forward feed period and a reverse feed period as one cycle, wherein
the welding system includes at least a welding control device, a welding power supply, a servo motor, and a servo amplifier configured to control the servo motor,
at least the servo amplifier and the welding power supply are directly or indirectly connected to each other via a digital communication,
the servo amplifier is configured to
generate a feed command for forward feeding or reverse feeding based on setting information input via the digital communication from a device other than the servo amplifier among the devices constituting the welding system,
output a control signal based on the generated feed command to the servo motor, and
output a synchronization signal related to the generated feed command to the welding power supply, and
the welding power supply is configured to calculate a wire position phase based on the synchronization signal.

10. The communication connection method according to claim 9, wherein
the digital communication is a digital communication connected via an industrial field network, and
the servo amplifier, the welding control device, and the welding power supply are connected to one another in this order in a line configuration, or the servo amplifier, the welding power supply, and the welding control device are connected to one another in this order in a line configuration.

11. The welding system according to claim 2, wherein
the welding power supply and the servo amplifier are connected to each other at least via an analog input and output, and
at least the synchronization signal is input to the welding power supply from the servo amplifier via the analog input and output.

12. The welding system according to claim 3, wherein
the welding power supply and the servo amplifier are connected to each other at least via an analog input and output, and
at least the synchronization signal is input to the welding power supply from the servo amplifier via the analog input and output.

13. The welding system according to claim 4, wherein
the welding power supply and the servo amplifier are connected to each other at least via an analog input and output, and
at least the synchronization signal is input to the welding power supply from the servo amplifier via the analog input and output.
